(19) United States
(12) Patent Application Publication
(10) Pub. No.: US 2009/0094333 A1
(43) Pub. Date: Apr. 9, 2009

(54) Collaborative Electronic Mail Filtering

(76) Inventor: Nikos Kyprianou, Nicosia (CY)

Correspondence Address: GOWLING LAFLEUR HENDERSON LLP, SUITE 1600, 1 FIRST CANADIAN PLACE, 100 KING STREET WEST, TORONTO, ON, M5X 1G5, CA

(21) Appl. No.: 11/866,467

(22) Filed: Oct. 3, 2007

(51) Int. Cl. G06F 15/16

(52) U.S. Cl. 709/206

(57) ABSTRACT

A method is provided for collaboratively maintaining a filter program for a device. The method comprises the following steps. The filter program is registered with a remote program in order to receive spam e-mail filter updates. Notification messages are then received from the remote program. The notification messages comprise spam e-mail filter updates defining at least one filter expression received at the remote program from a third party. The filter expression is applied at the filter program for identifying spam e-mail messages and the spam e-mail messages to the device are filtered. A computer readable medium comprising instructions for executing the method and a computing device configured to implement the method are also provided.

The present invention relates generally to electronic mail filtering and specifically to a system and method for filtering unsolicited electronic mail using collaborative measures.

### BACKGROUND

The continued growth of telecommunication networks has led to the proliferation of the Internet. The Internet is a worldwide, publicly accessible network of interconnected computer networks that transmit data using a standard protocol. The Internet consists of smaller domestic, academic, business, and government networks, which together carry various information and services, such as electronic mail, online chat, file transfer, Web pages and other documents of the World Wide Web.

The growth of the Internet has led to a subsequent increase in the use of personal computing devices. In addition to personal computers and notebooks, there has been an increase in the adoption of Personal Digital Assistants (PDAs) and smart-phones such as the Blackberry® by Research in Motion Limited or the Treo™ by Palm, Inc.

However, the expansion of the Internet is not without its problems. One such problem is referred to as spam, or spamming. Spamming is generally understood to mean the abuse of electronic messaging systems to indiscriminately send unsolicited bulk messages. While the most widely recognized form of spam is e-mail spam, the term may be applied to similar abuses in other media.

Spamming is economically viable because spammers have little to no operating costs beyond the management of their mailing lists. Furthermore, it is difficult to hold spammer accountable for their mass mailings. Because the cost associated with sending spam is relatively low to the spammer, there are a large number of spammers and the volume of unsolicited mail has become very high.

Accordingly, productivity of employees decreases as they attempt to filter out useful messages from unsolicited email. Furthermore, network bandwidth is wasted transmitting spam. This is particularly true for mobile communication devices, such as PDAs.

In an attempt to reduce the effect of spam, many e-mail servers offer some sort of spam filter, using a number of different filtering algorithms. For example, mobile communication devices with e-mail capability are typically deployed within an enterprise employing an existing Information Technology (IT) infrastructure. In such an infrastructure, messaging servers such as Microsoft Exchange server and IBM Lotus Domino are coupled with a routing server or software. The messaging servers often implement a spam filter to reduce the number of spam messages being transmitted to the mobile communication device.

However, even when spam filters are in place, unsolicited e-mail messages can still get through. Further, once an e-mail is in the user's inbox, it has to be manually removed. Accordingly, it is desirable to provide e-mail filtering that further improves on current filtering implementations.

### BRIEF DESCRIPTION OF THE DRAWINGS

Embodiments will be described by way of example only with reference to the following figures in which:

FIG. 1 is a block diagram illustrating a communication infrastructure; and

FIG. 2 is a flow chart illustrating operation of an embodiment of the invention.

### DETAILED DESCRIPTION OF THE PREFERRED EMBODIMENTS

In accordance with an aspect of the description there is provided a method for collaboratively maintaining a filter program for a device, the method comprising the steps of: registering the filter program with a remote program to receive spam e-mail filter updates; receiving notification messages from the remote program, the notification messages comprising spam e-mail filter updates defining at least one filter expression received at the remote program from a third party; applying the filter expression at the filter program for identifying spam e-mail messages; and filtering the spam e-mail messages to the device.

In accordance with a further aspect of the description there is provided a computer readable medium and a computing device configured to implement the steps described above.

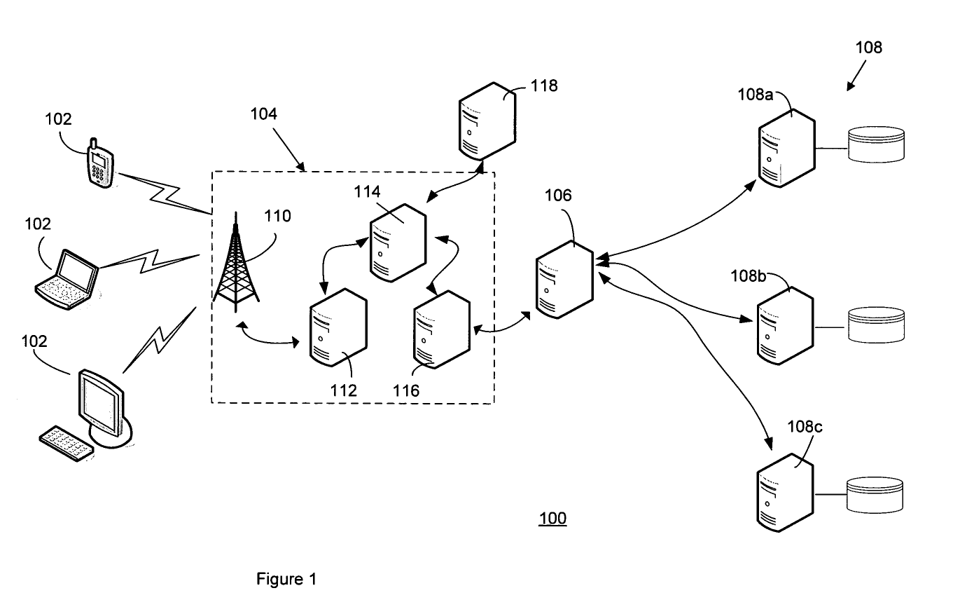

For convenience, like numerals in the description refer to like structures in the drawings. Referring to FIG. 1, a communication infrastructure is illustrated generally by numeral 100. The communication infrastructure 100 comprises a plurality of communication devices 102, or simply devices 102, a communication network 104, a gateway server 106, a messaging server 118 and a plurality of data-sources 108.

The devices 102 may include both wired and wireless computing devices such as a desktop computer, a notebook or other portable computer, a smart phone, a personal digital assistant (PDA), and the like. The devices 102 are in communication with the gateway server 106 via the communication network 104. Accordingly, the communication network 104 may include several components such as a wireless network 110, a relay 112, a corporate server 114 and/or a mobile data server 116 for relaying data between the devices 102 and the gateway server 106. The corporate server 114 is also coupled with the messaging server 118. The corporate server includes an e-mail application that interrogates the messaging server 118 for new e-mail messages and forwards them to the appropriate devices 102. The actual configuration of the communication network 104 may vary, depending on the type of device 102, as will be appreciated by a person of ordinary skill in the art.

The gateway server 106 is further in communication with a plurality of the data-sources 108, such as Web services 108a, database services 108b, as well as other enterprise services 108c, via a suitable link. For example, the gateway server 110 is connected with the Web services 108a and database services 108b via Simple Object Access Protocol (SOAP) and Java Database Connectivity (JDBC) respectively. Other types of data-sources 108 and their corresponding links will be apparent to a person of ordinary skill in the art.

In accordance with the present embodiment, a remote spam filter program is provided. In the present embodiment, the remote spam filter program is a spam web service 108a. The spam web service 108a provides spam filter notifications to devices 102 registered therewith. Accordingly, a number of devices 102 are typically registered with the spam web service 108a. In the present embodiment, this is achieved by the devices 102 submitting a notification request to the spam web service 108a.

The devices 102 can register to receive all filter notifications. Alternatively, the devices 102 can register to receive only filter notifications for filter expressions that meet specific criteria. Such criteria can include for example, the type of spam filter, the origin of the spam filter (i.e. who submitted the spam filter) and the like, and can be submitted along with the notification request.

Accordingly, a collaborative spam filter can be implemented for the registered devices 102. That is, when one of devices 102 identifies an e-mail message as spam, a message is sent to the web service 108a. The message includes a filter expression for the spam e-mail message. The web-service 108a then broadcasts a notification message to the registered devices 102, providing them with the filter expression as an update to their existing spam filter.

In the present embodiment, communication between the devices 102 and the web service 108a is facilitated by a filter application executing on the mobile data server 116. The filter application is further designed to interact with the e-mail application executing on the corporate server 114.

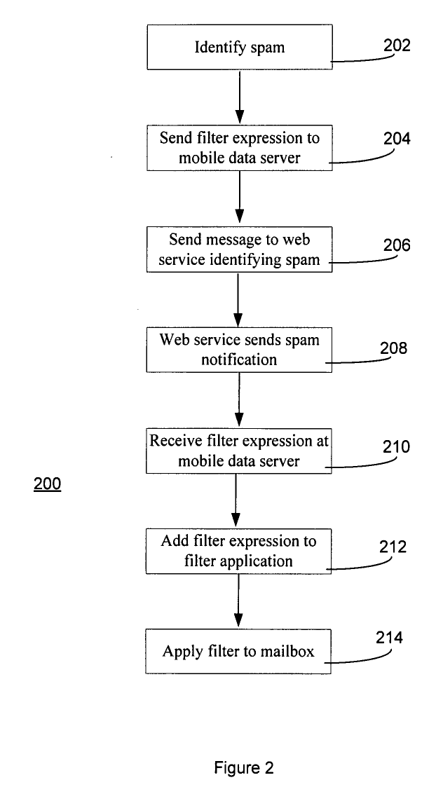

Referring to FIG. 2, a flow chart illustrating steps for implementing the present embodiment is shown generally by numeral 200. In step 202, a received e-mail message is identified as spam.

In step 204, the device 102 sends a filter expression to the filter application on the mobile data server 116 that would identifying the spam e-mail message. The filter expression can be one or more of a number of different terms used to identify the message as spam, including, for example, an originating e-mail address, a subject line, content, and/or a particular phrase.

In step 206, the filter application sends a message to the spam web service 108b identifying the filter expression received from the device 102.

In step 208, the spam web service 108a transmits the filter expression to the mobile data servers 114 correlated with target devices using a notification message. Target devices are those devices 102 that are registered with the spam web service 108a and for which the filter expression meets the specific criteria, if any, defined during registration.

In step 210, the filter applications executing on the mobile data servers 114 correlated with the target devices receive the notification message and retrieve the filter expression. In step 212, the filter expression is added to a collection of previously defined filter expressions and in step 214 it is applied to messages in an inbox for the device 102. By applying the filter expression, the filter application filters potential spam e-mails from the device 102. The filter application can apply the filter expression in a number of different ways, as will be appreciated by a person of ordinary skill in the art. For example, the filter application can inhibit e-mail messages identified as spam from being sent to the device 102. Alternatively, e-mail messages identified as spam can be marked accordingly and transmitted to the device 102. In this example, spam e-mail messages can be identified visually using a specific icon, isolated in a spam folder or both.

Further, the filter application can access the device's mailbox on the messaging server 118 and apply the filter expression. Therefore, even if a spam message had already been delivered to the device 102, the filter application can still identify the message as spam and either delete the e-mail message from the device or mark it as spam, as discussed above.

As an option, each user can individually configure the filter application for his/her device 102 to allow or block specific e-mail addresses and/or content to help reduce the chance that a valid message is misidentified as a spam or vice versa.

Accordingly, it will be appreciated by a person of ordinary skill in the art that the filter application described above provide the ability to share filter definitions between willing participants. By sharing filter definitions, it is likely that each device 102 will receive less spam e-mail messages than relying on establishing it's own filter definitions.

Using the foregoing specification, the invention may be implemented as a machine, process or article of manufacture by using standard programming and/or engineering techniques to produce programming software, firmware, hardware or any combination thereof.

Any resulting program(s), having computer-readable program code, may be embodied within one or more computer-usable media such as memory devices or transmitting devices, thereby making a computer program product or article of manufacture according to the invention. As such, the terms “software” and “application” as used herein are intended to encompass a computer program existent (permanently, temporarily, or transitorily) on any computer-usable medium such as on any memory device or in any transmitting device.

Examples of memory devices include, hard disk drives, diskettes, optical disks, magnetic tape, semiconductor memories such as FLASH, RAM, ROM, PROMS, and the like. Examples of networks include, but are not limited to, the Internet, intranets, telephone/modem-based network communication, hard-wired/cabled communication network, cellular communication, radio wave communication, satellite communication, and other stationary or mobile network systems/communication links.

A machine embodying the invention may involve one or more processing systems including, for example, CPU, memory/storage devices, communication links, communication/transmitting devices, servers, I/O devices, or any subcomponents or individual parts of one or more processing systems, including software, firmware, hardware, or any combination or subcombination thereof, which embody the invention as set forth in the claims.

Using the description provided herein, those skilled in the art will be readily able to combine software created as described with appropriate general purpose or special purpose computer hardware to create a computer system and/or computer subcomponents embodying the invention, and to create a computer system and/or computer subcomponents for carrying out the method of the invention.

Further, it will be apparent that various modifications and additions can be made to the embodiments discussed herein without departing from the scope or spirit of the present invention. For example, although the previous embodiment described the notification as being transmitted to the filter application, it may also be possible to transmit the notifications directly from the web service 108a to the device 102 itself.

As another example, in the previous embodiment the filter expression for an identified spam e-mail message is created on the device 102, submitted to the filter application on the mobile data server 116, and then submitted to the web service 108a. In an alternative embodiment, the device 102 need only identify the spam e-mail message. In this embodiment, the filter application automatically parses the spam e-mail message and determines the filter expression using a predefined algorithm.

In yet another example, the filter application is described as executing on the mobile data server 102. In an alternative embodiment, if the device 102 is sufficiently sophisticated to execute it, the filter application can be installed and executed direction on the device 102 itself.

Accordingly, the scope of the present invention should not be limited by the particular embodiments discussed above, but should be defined only by the claims set forth below and equivalents thereof.

1. A method for collaboratively maintaining a filter program for a device, the method comprising the steps of:
registering the filter program with a remote program to receive spam e-mail filter updates;
receiving notification messages from the remote program, the notification messages comprising spam e-mail filter updates defining at least one filter expression received at the remote program from a third party;
applying the filter expression at the filter program for identifying spam e-mail messages; and
filtering the spam e-mail messages to the device.

2. The method of claim 1, wherein the remote program is a spam web service.

3. The method of claim 1, wherein the filter program is executing on a mobile data server.

4. The method of claim 1, wherein the filter program is executing on the device.

5. The method of claim 1, wherein the step of filtering the spam e-mail messages comprises inhibiting the spam e-mail messages from being transmitted from the device.

6. The method of claim 1, wherein the step of filtering the spam e-mail messages comprises adding an identifier to the spam e-mail message for display on the device.

7. The method of claim 1, wherein the step of registering the filter program with the remote program comprises identifying predefined specific criteria for the filter expression in order to receive the notification message.

8. A computer readable medium comprising instructions, which, when executed on a computing device configured to collaboratively maintain a filter program for a mobile communication device, cause the computing device to implement the steps of:
registering the filter program with a remote program to receive spam e-mail filter updates;
receiving notification messages from the remote program, the notification messages comprising spam e-mail filter updates defining at least one filter expression received at the remote program from a third party;
applying the filter expression at the filter program for identifying spam e-mail messages; and
filtering the spam e-mail messages to the device.

9. The computer readable medium of claim 8, wherein the computing device is a mobile data server.

10. The computer readable medium of claim 8, wherein the computing device is the mobile communication device.

11. A computing device for collaboratively maintaining a filter program for a mobile communication device, the computing device comprising:
a communication device configured to communicate with a remote program;
storage for storing at least one filter expression; and
a processor configured to:
register the filter program with the remote program via the communication device in order to receive spam e-mail filter updates;
receiving notification messages from the remote program via the communication device, the notification messages comprising spam e-mail filter updates defining at least one filter expression received at the remote program from a third party;
applying the filter expression at the filter program for identifying spam e-mail messages; and
filtering the spam e-mail messages to the device.

12. The computing device of claim 11, wherein the remote program is a spam web service.

13. The computing device of claim 11, wherein the computing device is the mobile data server.

14. The computing device of claim 11, wherein the computing device is the mobile communication device.

15. The computing device of claim 11, wherein processor is configured to filter the spam e-mail messages by inhibiting the spam e-mail messages from being transmitted from the device.

16. The computing device of claim 11, wherein processor is configured to filter the spam e-mail messages by adding an identifier to the spam e-mail message from display on the device.

17. The computing device of claim 11, wherein the processor is configured to register the filter program with the remote program by identifying predefined specific criteria for the filter expression in order to receive the notification message.
